(19) United States
(12) Patent Application Publication
(10) Pub. No.: US 2014/0197161 A1
(43) Pub. Date: Jul. 17, 2014

(54) DOOR SWITCH APPARATUS FOR MICROWAVE OVENS

(71) Applicant: Standex International Corporation, Salem, NH (US)

(72) Inventor: Michael J. Dobie, Lewisville, TX (US)

(73) Assignee: STANDEX INTERNATIONAL CORPORATION, Salem, NH (US)

(21) Appl. No.: 14/155,628

(22) Filed: Jan. 15, 2014

Related U.S. Application Data
(60) Provisional application No. 61/753,099, filed on Jan. 16, 2013.

(51) Int. Cl. H05B 6/64

(52) U.S. Cl. CPC H05B 6/6417
USPC 219/724

(57) ABSTRACT

A door switch apparatus for a microwave oven that disables the microwave system while not requiring any separate “fingers” or tongs on the door face to reach into the main body of the oven to activate a switch. The switch uses stackable switches activated by a single switch lever. The switch lever is preferably made from a solid piece of ultra-high molecular weight polyethylene (UHMV to keep the accuracy of the angular dimensions between the surfaces contacting the door hinge arm and the arm of switch to remain fixed.

This application claims benefit of U.S. Provisional Application Ser. No. 61/753,099 filed Jan. 16, 2013 pursuant to 35 USC§119(e).

### FIELD OF THE INVENTION

This invention relates to the field of microwave ovens, in particular, door activated switches that deactivate the microwave producing mechanism if the door is ajar.

### BACKGROUND OF THE INVENTION

Microwave oven door switches must be mechanically and electrically reliable for 200,000 cycles or more to deactivate the microwave producing systems prior to motion of the door away from the oven face. No microwave power is allowed to leak from the oven door in excess of a governmental agency standard. In addition, the adjustment of these switch mechanisms must be accomplished with minimal time and effort during manufacturing and testing of new ovens or in the repair of used ovens.

As shown in FIG. 1, the majority of prior art microwave equipped ovens have separate “fingers” or projections 32 that reach into the oven body 30 and activate switches 34 when door 28 is closed and opened. Slots 29 on front panel 27 provide access to switches 34. Locking mechanism 33 on finger 32 engages switch 34 to keep the door 28 closed unless intentionally pulled open by a user. Fingers 32 can easily be bent or get out of adjustment especially in a commercial environment.

There is not found in the prior art, a door switching apparatus that is activated without using fingers or projections from the inner face of the door of a microwave oven that will deactivate the oven when the door is not tightly shut or opened and uses stackable switches activated by a single switch lever.

### SUMMARY OF THE INVENTION

It is an aspect of the invention to provide a door switch apparatus that disables the microwave system while not requiring any separate “fingers” or tongs on the door face to reach into the main body of the oven to activate a switch.

### BRIEF DESCRIPTION OF THE DRAWINGS

FIG. 1 is an isometric view of a typical door switch device found in the prior art.

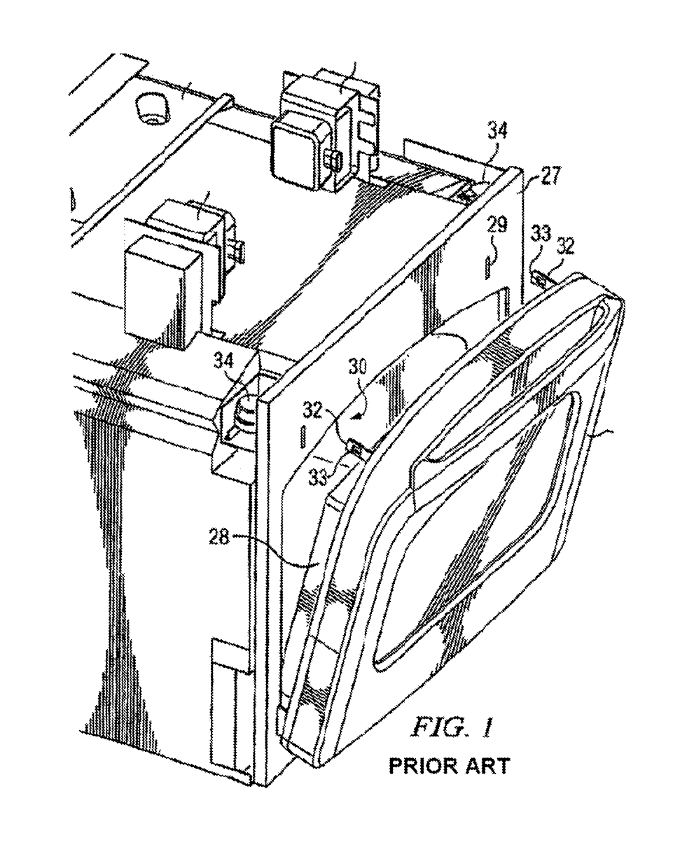

FIG. 2 is a side view of a microwave oven with a door switch apparatus installed thereon in accordance with the invention.

FIG. 3 is a detailed side view of the door switch apparatus as indicated by the dotted line shown in FIG. 2.

### DETAILED DESCRIPTION OF THE INVENTION

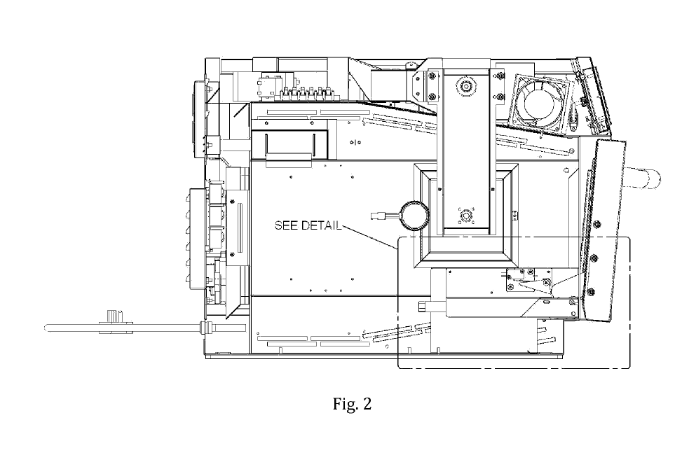

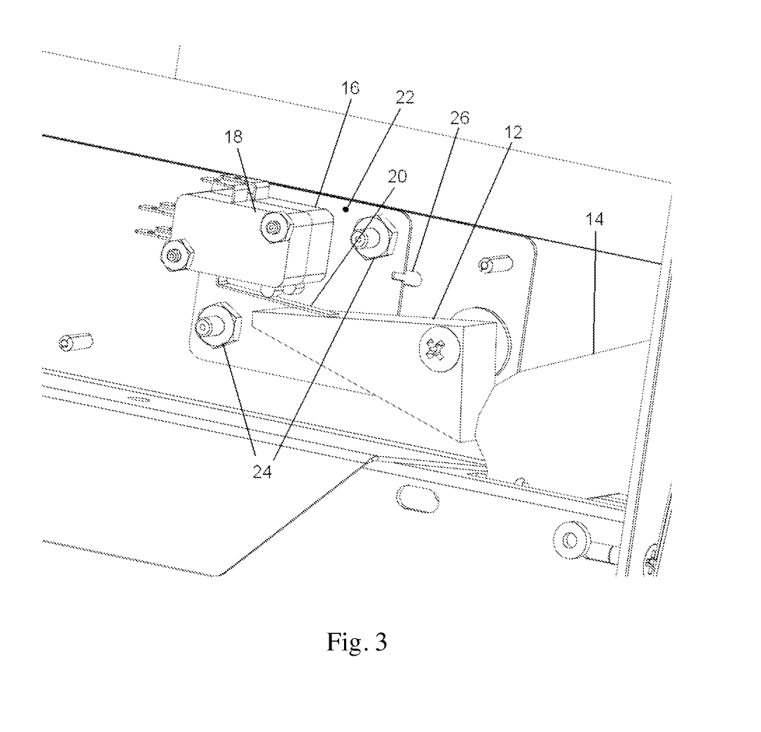

Referring now to FIGS. 2 and 3, the invention is described in detail. Two switches 16, 18 are operated by activating switch lever/actuator 12 that is in contact with hinge arm 14 only. Switch 16 is preferably a miniature snap action switch as made by Honeywell, Model Number V7-1Z19E9 and switch 18 is preferably the same model but having arm 20. Switch lever 12 is preferably made from a solid piece of ultra-high molecular weight polyethylene (UHMV); however, other materials providing the same ease of manufacture and dimensional stability could also be used. By using UHMV and by making this element from a solid piece, the accuracy of the angular dimensions is easy to maintain. However, this part does not necessarily have to be solid. As long as the angle between the surfaces contacting door hinge arm 14 and arm 20 of switch 18 remain fixed, the invention will function as intended.

Switch lever 12 is designed to amplify the motion of the door by a factor of approximately 3. That is, for a movement of door hinge arm 14 of 1 mm, the activating portion of switch lever 12 moves approximately 3 mm.

This embodiment functions without the use of springs, which are commonly used to deactivate the switches. It is designed to use gravity to return switch lever 12 to its resting position.

In a microwave oven, multiple electrical switches are required to meet safety regulations. To meet these regulations, electrical switches 16, 18 must activate in a particular order. In this embodiment, this is accomplished by having miniature snap action switches 18 equipped with an activating arm 20 while electrical switch 16 has no additional arm 20.

During a door closing, electrical switch 18 with arm 20 is always activated first, followed by electrical switch 16 without an arm. This allows the use of the same switch level 12 to operate both electrical switches 16, 18. Electrical switches 16, 18 can be stacked and mounted together; this accomplishes something that prior art devices cannot do because the activating fingers 32 and their corresponding switches 34 of prior art devices must be placed at a distance from one another.

During the life of the oven and during manufacture of the oven, switches 16, 18 may need to be adjusted to activate properly. This is accomplished by mounting the electrical switches 16, 18 on a separate plate 22 from the switch level 12 and hinge 14. Plate 22 is easily moved by loosening nuts 24 on plate 22 and moving plate 22 by inserting a screwdriver into slot 26 on the edge of plate 22 and rotating the screwdriver.

Although the present invention has been described with reference to certain preferred embodiments thereof, other versions are readily apparent to those of ordinary skill in the preferred embodiments contained herein.

What is claimed is:

1. A latching mechanism for a microwave oven having a closable door, said mechanism comprising:
a hinge arm that is pivotally attached to the closable door on the microwave oven;
an actuator arm that is pivotally attached to the microwave oven with said actuator arm having a switch surface and a hinge surface with said surfaces at a predetermined fixed angular relationship to one another;
a first switch having an activation arm that is in contact with said switch surface of said actuator arm such that when the door of the microwave is properly closed, said hinge arm, that is in contact with said hinge surface of said actuator arm, urges said actuator arm to push against said activation arm of said first switch thus causing said first switch to activate to indicate the door of said microwave is closed properly and causes said microwave to be operable.)

2. The latching mechanism of claim 1 further comprising a second switch without an activating arm but is in electrical communication with said first switch wherein activation of said first switch results in activation of said second switch, thus indicating the door of the microwave is properly closed since both said first and said second switches were properly activated and in the proper order.)

3. The latching mechanism of claim 2 where said first and second switches are stacked and mounted together.)

4. The latching mechanism of claim 3 wherein said first and second switches are stacked and mounted together on a easily adjustable mounting plate which is attached to said microwave oven.)

5. The latching mechanism of claim 4 wherein said adjustable mounting plate is mounted using at least two nuts that can be easily loosening and wherein said adjustable mounting plate further comprising a slot adapted to fit a screw driver such when the mounting nuts are loosened and wherein a screw driver is inserted in said slot, said adjustable mounting plate can be adjusted in order to have said switches activate properly.)

6. The latching mechanism of claim 1 wherein said actuator arm is configured to amplify the motion of the door by a factor of approximately 3, thus for a movement of 1 mm of hinge arm, actuator arm moves 3 mm.)

7. The latching mechanism of claim 2 wherein said actuator arm will deactivate said first and second switches when the door of the microwave oven is opened, thus causing the microwave oven to be inoperable.

8. The latching mechanism of claim 7 wherein said actuator arm will return to its resting position, that is when the door is open, by the force of gravity alone.
